(19) United States
(12) Patent Application Publication
(10) Pub. No.: US 2013/0151534 A1
(43) Pub. Date: Jun. 13, 2013

(54) MULTIMEDIA METADATA ANALYSIS USING INVERTED INDEX WITH TEMPORAL AND SEGMENT IDENTIFYING PAYLOADS

(71) Applicant: Digitalsmiths, Inc., Durham, NC (US)

(72) Inventors: David Luks, Chapel Hill, NC (US); Doug Mittendorf, Durham, NC (US)

(73) Assignee: Digitalsmiths, Inc., Durham, NC (US)

(21) Appl. No.: 13/710,435

(22) Filed: Dec. 10, 2012

Related U.S. Application Data
(60) Provisional application No. 61/568,414, filed on Dec. 8, 2011.

(51) Int. Cl. G06F 17/30

(52) U.S. Cl. CPC G06F 17/30622
USPC 707/742

(57) ABSTRACT

The addition of relative term positions, temporal positions, and segment identifiers to an inverted index allows for temporal and phrase queries of multimedia assets. Segment identifiers enable any search results to be examined in context. The system makes advantageous use of Lucene's binary payload functionality to store temporal data and segment identifiers as additional binary data for each term instance in the inverted index. The payloads are made up of three variable-length integers, which account for twelve extra bytes of metadata, which are stored for each term instance. A content database on a Master/Administrator server node provides the indexes for search into content in response to user events, returning results in JSON format. The search results may then be used to locate and present content segments to a user containing both requested search term results and the time location within the multimedia asset in which the search term(s) is found.

### CROSS REFERENCE TO RELATED APPLICATION

This application claims the benefit under 35 U.S.C. §119(e) of U.S. Provisional Patent Application No. 61/568,414, entitled “Word Level Inverted Index with Temporal Payloads,” filed Dec. 8, 2011, which is incorporated herein by reference in its entirety.

### FIELD OF THE PRESENT INVENTION

The present inventions relate generally to the navigation and searching of metadata associated with digital media. More particularly, the present systems and methods provide a computer-implemented system and user interface to make it quick and easy to navigate, search for, and manipulate specific or discrete scenes or portions of digital media by taking advantage of time-based or time-correlated metadata associated with segments of the digital media.

### BACKGROUND OF THE PRESENT INVENTION

The Internet has made various forms of content available to users across the world. For example, consumers access the Internet to view articles, research topics of interest, watch videos, and the like. Online viewing of multimedia or digital media has become extremely popular in recent years. This has led to the emergence of new applications related to navigating, searching, retrieving, and manipulating online multimedia or digital media and, in particular, videos, such as movies, TV shows, and the like. Although users sometimes just want to browse through broad categories of videos; more often, users are interested in finding very specific characters, scenes, quotations, objects, actions, or similar discrete content that exists at one or more specific points in time inside a movie or specific TV episode.

Video content is intrinsically multimodal and merely being able to search for one element, such as a quote, is beneficial, but does not provide or allow for the capability to search for multiple elements of content that intersect within specific scenes or segments of a video and that may not include any specific spoken text. The multimodality of video content has been generally defined along three information channels: (1) a visual modality—that which can be visually seen in a video, (2) an auditory modality—speech or specific sounds or noises that can be heard in a video, and (3) a textual modality—descriptive elements that may be appended to or associated with an entire video (i.e., conventional metadata) or with specific scenes or points in time within a video (i.e., time-based or time-correlated metadata) that can be used to describe the video content in greater, finer, and more-nuanced detail than is typically available from just the visual or textual modalities. For each of these modalities, there is also a temporal aspect. While some content and information can be used generally to describe the entire video—there is a tremendous wealth of information that can be gleaned and used if the information is tied specifically to the point or points in time within the video in which specific events or elements or information occurs. Thus, indexing and very precise, targeted searching within videos is a complex issue and is only as good as the accuracy and sufficiency of the metadata associated with the video and, particularly, with the time-based segments of the video.

The growing prominence and value of digital media, including the libraries of full-featured films, digital shorts, television series and programs, news programs, and similar professionally (and amateur) made multimedia (previously and hereinafter referred to generally as “videos” or “digital media” or “digital media assets or files or content”), requires an effective and convenient manner of navigating, searching, and retrieving such digital media as well as any related or underlying metadata for a wide variety of purposes and uses.

“Metadata,” which is a term that has been used above and will be used herein, is merely information about other information—in this case, information about the digital media, as a whole, or associated with particular images, scenes, dialogue, or other subparts of the digital media. For example, metadata can identify the following types of information or characteristics associated with the digital media, including but not limited to actors appearing, characters appearing, dialog, subject matter, genre, objects appearing in a scene, setting, location of a scene, themes presented, or legal clearance to third party copyrighted material appearing in a respective digital media asset. Metadata may be related to the entire digital media asset (such as the title, date of creation, director, producer, production studio, etc.) or may only be relevant to particular scenes, images, audio, or other portions of the digital media.

Preferably, when such metadata is only related to a sub portion of the digital media, it has a corresponding time-base (such as a discreet point in time or range of times associated with the underlying time-codes of the digital media). An effective and convenient manner of navigating, searching, and retrieving desired digital media can be accomplished through the effective use of metadata, and preferably several hierarchical levels or layers of metadata, associated with digital media. Further, when such metadata can be tied closely to specific and relevant points in time or ranges of time within the digital media asset, significant value and many additional uses of existing digital media become available to the entertainment and advertising industries, to mention just a few.

The present inventions, as described and shown in greater detail hereinafter, address and teach one or more of the above-referenced capabilities, needs, and features that would be useful for a variety of businesses and industries as described, taught, and suggested herein in greater detail.

### SUMMARY OF THE PRESENT INVENTION

The present inventions relate generally to the navigation and searching of metadata associated with digital media. More particularly, the present systems and methods provide a computer-implemented system and user interface to make it quick and easy to navigate, search for, and manipulate specific or discrete scenes or portions of digital media by taking advantage of time-based or time-correlated metadata associated with segments of the digital media.

The addition of relative term position and temporal data to an inverted index of metadata terms associated with digital media assets allows for temporal queries in addition to or in combination with phrase queries. Additional binary data for each term instance is stored in the word-level inverted index to enable a user to run searches using time-based queries. Advantageously, by also adding a specific segment identifier to each instance of a metadata term contained in the inverted index, it is possible for searches to be conducted against discrete segment. In addition, such segment identifiers or pointers can be used quickly and readily to determine the context or rationale as to why each search result has been returned in response to a search query. The system makes advantageous use of Lucene's binary payload functionality to store this additional binary data (temporal data and segment identifiers) for each term instance in the inverted index. The payloads are made up of three (3) variable-length integers, which account for twelve (12) extra bytes of metadata, which are stored for each term instance. The customized payload fields consist of three (3) integers, which account for twelve (12) extra bytes that are stored for each instance of each metadata term contained in the inverted index.

These customized payload fields are: Time In/Start Time—which represents the start point of the segment in which the particular instance of a metadata term occurs (in the preferred embodiment, rounded down to the nearest second), Time Out/End Time—which represents the end point of the segment in which the particular instance of the metadata term occurs (in the preferred embodiment, rounded up to the nearest second), and Segment Identifier—which identifies the unique segment of the multimedia asset with which the particular instance of the metadata term is associated. In some embodiments, the Segment Identifier is a unique identifier or a pointer to the relevant source segment associated with the multimedia asset. In a preferred embodiment, as part of the indexing process, all metadata segments associated with a digital media asset are serialized into a single, compressed file format, called hereinafter a source segment blob. The blob contains n number of bytes representing all of the discrete, serialized segments of the digital media asset source. If the first segment of the source segment blob is deemed to be at byte location 0, then the location of each segment can be identified by its byte offset location within the source segment blob. In that case, the Segment Identifier can also be referred to as a Segment Byte Offset. Although some embodiments can use the unique segment ID or a pointer into the segment database containing the raw segment data, use of a serialized, compressed segment blob (e.g., a single file containing a mirror copy of all of the raw segments kept in the database) enables more efficient and quicker searching capability and faster search query responses since the data can be identified and/or retrieved more quickly from a single file than from a database.

After incoming content data has been processed into segments that each include the payload information for each segment, the content segments are sorted by both start time (Time In) and end time (Time Out) and further processed into term/segment instances. All of the term/segment instances, with associated payload data, are stored in a master database persisted on a Master/Administrator server node. The content database on the Master/Administrator server node provides the indexes for search into content in response to user events, preferably returning results in Java Script Object Notation (JSON) format. The search results may then be used to locate and present content segments to the user containing both the requested search term(s) and the time location(s) within the digital media asset where the search term(s) is found.

In a first aspect, a system for indexing multimedia digital content, comprises: receiving at a data aggregator time-based metadata associated with the multimedia digital content, the time-based metadata being organized into a plurality of raw content segments, each raw content segment comprising a textual description, a start time, and a stop time, where the start time and the stop time define a time-based portion of the multimedia digital content; storing the plurality of raw content segments in a database in electronic communication with the data aggregator, each of the raw content segments being retrievable from the database based on a segment identifier assigned to each of the respective raw content segments; using a computer processor, normalizing the plurality of raw content segments, where the textual description of each raw content segment includes one or more terms; and creating a searchable inverted index for the multimedia digital content that defines a segment instance for each occurrence of the one or more terms from the textual description of the plurality of normalized content segments associated with the time-based metadata, where each segment instance is associated with at least one of the plurality of raw content segments stored in the database; wherein, in response to a time-based search query containing at least one term, the system is configured to identify from the searchable inverted index each segment instance associated with the at least one term, retrieve from the database the raw content segments associated with each of the identified segment instances, and retrieve the time-based portion of the multimedia digital content defined by each of the retrieved raw content segments.

In one embodiment, each segment instance includes data fields containing: (i) a word order position assigned to the respective term from the textual description, (ii) the start time of the normalized content segment containing the respective term, (iii) the stop time of the normalized content segment containing the respective term, and (iv) the segment identifier of the associated at least one raw content segment stored in the database. Preferably, the system indexes a plurality of multimedia digital content, each respective multimedia digital content has a document ID, and each segment instance further includes a data field containing the document ID of the respective multimedia digital content containing the respective term. In another preferred embodiment, the word order position assigned to the respective term enables searching of multi-term phrases.

In another embodiment, each raw content segment further comprises a track type, where each track type defines a group of similar raw content segments. Preferably, the system further comprises creating a track-level searchable inverted index for one or more of the track types associated with the raw content segments.

In a further embodiment, the system further comprises storing the plurality of raw content segments in sequential time order in the database.

In another embodiment, the time-based search query is a Boolean search query containing at least two terms. Preferably, the Boolean search query includes at least one of an AND, OR, and NOT operator between the at least two terms. In yet a further embodiment, the time-based search query includes a time span search query containing at least two terms. Preferably, the time span search query includes at least one of CONTAINING, NOT CONTAINING, NEAR, and NOT NEAR operator between the at least two terms.

In yet a further embodiment, the segment identifier is a pointer to the database. In another embodiment, the database is a segments blob of data. Preferably, the segments blob comprises the plurality of raw content segments stored in sequential time order. In an embodiment, the unique segment identifier is a byte offset value associated with the bytes of data within the segments blob.

In a further embodiment, normalizing the plurality of raw content segments includes one or more of: tokenizing the one or more terms, stemming the one or more terms, identifying synonyms for the one or more terms, lower-casing the one or more terms, and spell correcting the one or more terms.

In another embodiment, normalizing the plurality of raw content segments includes making data fields of the raw content segments consistent regardless of their source.

In an embodiment, the start time and stop time of each respective raw content segment and the segment identifier of each respective raw content segment are stored in Lucene binary payloads.

In a second aspect, a system for searching for a desired time-based portion of a multimedia digital asset, comprises: a processor and a computer program product that includes a computer-readable medium that is usable by the processor, the medium having stored thereon a sequence of instructions that when executed by the processor causes the execution of the steps of: receiving time-based metadata associated with the multimedia digital asset, the time-based metadata being organized into a plurality of raw content segments, each raw content segment comprising a textual description, a start time, and a stop time, where the start time and the stop time define a respective time-based portion of the multimedia digital asset; storing the plurality of raw content segments in a database, each of the raw content segments being retrievable from the database based on a segment identifier assigned to each of the respective raw content segments; normalizing the plurality of raw content segments, where the textual description of each raw content segment includes one or more terms; creating a searchable inverted index for the multimedia digital asset that defines a segment instance for each occurrence of the one or more terms from the textual description of the plurality of normalized content segments associated with the time-based metadata; associating each segment instance with at least one of the plurality of raw content segments stored in the database; receiving a time-based search query with parameters containing at least two terms and a time relationship between the at least two terms; identifying from the searchable inverted index each segment instance satisfying the time-based search query; retrieving from the database the raw content segments associated with each of the identified segment instances; and retrieving the respective time-based portion of the multimedia digital asset defined by each of the retrieved raw content segments where one or more of the retrieved respective time-based portions of the multimedia digital asset represent the desired time-based portion of the multimedia digital asset.

In a preferred embodiment, each segment instance includes data fields containing: (i) a word order position assigned to a respective term from the textual description, (ii) the start time of the normalized content segment containing the respective term, (iii) the stop time of the normalized content segment containing the respective term, and (iv) the segment identifier of the associated at least one raw content segment stored in the database. Preferably, the system indexes a plurality of multimedia digital assets wherein each respective multimedia digital asset has a document ID, and wherein each segment instance further includes a data field containing the document ID of the respective multimedia digital asset containing the respective term. Additionally, the word order position assigned to the respective term enables searching of multi-term phrases.

In another preferred embodiment, each raw content segment further comprises a track type, where each track type defines a group of similar raw content segments. Preferably, the system further comprises creating a track-level searchable inverted index for one or more of the track types associated with the raw content segments.

In a preferred embodiment, the system further comprises storing the plurality of raw content segments in sequential time order in the database.

Preferably, the time-based search query is (i) a Boolean search query containing at least two terms or (ii) a time span search query containing at least two terms. Yet further, the Boolean search query includes at least one of an AND, OR, and NOT operator between the at least two terms and the time span search query includes at least one of CONTAINING, NOT CONTAINING, NEAR, and NOT NEAR operator between the at least two terms.

In another embodiment, the database is a segments blob of data comprising the plurality of raw content segments stored in sequential time order and wherein the unique segment identifier is a byte offset value associated with the bytes of data within the segments blob.

In a third aspect, a method for searching for a desired time-based portion of a multimedia digital content, comprises: receiving time-based metadata associated with the multimedia digital content, the time-based metadata being organized into a plurality of raw content segments, each raw content segment comprising a textual description, a start time, and a stop time, where the start time and the stop time define a respective time-based portion of the multimedia digital content; storing the plurality of raw content segments in a database, each of the raw content segments being retrievable from the database based on a segment identifier assigned to each of the respective raw content segments; normalizing the plurality of raw content segments, where the textual description of each raw content segment includes one or more terms; creating a searchable inverted index for the multimedia digital content that defines a segment instance for each occurrence of the one or more terms from the textual description of the plurality of normalized content segments associated with the time-based metadata; associating each segment instance with at least one of the plurality of raw content segments stored in the database; receiving a time-based search query containing at least one term; identifying from the searchable inverted index each segment instance associated with the at least one term; retrieving from the database the raw content segments associated with each of the identified segment instances; and retrieving the respective time-based portion of the multimedia digital content defined by each of the retrieved raw content segments where one or more of the retrieved respective time-based portions of the multimedia digital content represent the desired time-based portion of the multimedia digital content.

Preferably, each segment instance includes data fields containing: (i) a word order position assigned to a respective term from the textual description, (ii) the start time of the normalized content segment containing the respective term, (iii) the stop time of the normalized content segment containing the respective term, and (iv) the segment identifier of the associated at least one raw content segment stored in the database. In an embodiment, the multimedia digital contents includes a plurality of digital assets, wherein each respective digital asset has a document ID and wherein each segment instance further includes a data field containing the document ID of the respective digital asset containing the respective term.

In an embodiment, each raw content segment further comprises a track type, where each track type defines a group of similar raw content segments. Preferably, the method further comprises creating a track-level searchable inverted index for one or more of the track types associated with the raw content segments.

In another embodiment, the method further comprises storing the plurality of raw content segments in sequential time order in the database. Preferably, the time-based search query is (i) a Boolean search query containing at least two terms or (ii) a time span search query containing at least two terms. In an embodiment, the Boolean search query includes at least one of an AND, OR, and NOT operator between the at least two terms. In a further embodiment, the time span search query includes at least one of CONTAINING, NOT CONTAINING, NEAR, and NOT NEAR operator between the at least two terms.

In yet a further embodiment, the database is a segments blob of data comprising the plurality of raw content segments stored in sequential time order and wherein the unique segment identifier is a byte offset value associated with the bytes of data within the segments blob.

Embodiments of the invention can be implemented in digital electronic circuitry, or in computer hardware, firmware, software, or in combinations of one or more of the above. The invention, systems, and methods described herein may be implemented as a computer program product, i.e., a computer program tangibly embodied in an information carrier, e.g., in a machine-readable storage device or in a propagated signal, for execution by, or to control the operation of, data processing apparatuses, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps described herein can be performed by one or more programmable processors executing a computer program to perform functions or process steps or provide features described herein by operating on input data and generating output. Method steps can also be performed or implemented, in association with the disclosed systems, methods, and/or processes, in, as, or as part of special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are at least one processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with an end user, the invention can be implemented on a computer or computing device having a display, e.g., a cathode ray tube (CRT) or liquid crystal display (LCD) monitor or comparable graphical user interface, for displaying information to the user, and a keyboard and/or a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The inventions can be implemented in computing systems that include a back-end component, e.g., a data server, or that includes a middleware component, e.g., an application server, or that includes a front-end component, e.g., a client computer having a graphical user interface or a Web browser through which a user can interact with an implementation of the invention, or any combination of such back-end, middleware, or front-end components. The components of the system can be interconnected by any form or medium of digital data communication, e.g., a communication network, whether wired or wireless. Examples of communication networks include a local area network (LAN) and a wide area network (WAN), e.g., the Internet, Intranet using any available communication means, e.g., Ethernet, Bluetooth, etc.

The computing system can include clients and servers. A client and server are generally remote from each other and typically interact through a communication network. The relationship of client and server arises by virtue of computer programs running on the respective computers and having a client-server relationship to each other.

The present invention also encompasses computer-readable medium having computer-executable instructions for performing methods, steps, or processes of the present invention, and computer networks and other systems that implement the methods, steps, or processes of the present invention.

The above features as well as additional features and aspects of the present invention are disclosed herein and will become apparent from the following description of preferred embodiments of the present invention.

This summary is provided to introduce a selection of aspects and concepts in a simplified form that are further described below in the detailed description. This summary is not necessarily intended to identify all key or essential features of the claimed subject matter, nor is it intended to be used to limit the scope of the claimed subject matter.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there is shown in the drawings example constructions of the embodiments; however, the embodiments are not limited to the specific methods and instrumentalities disclosed. In addition, further features and benefits of the present inventions will be apparent from a detailed description of preferred embodiments thereof taken in conjunction with the following drawings, wherein similar elements are referred to with similar reference numbers, and wherein:

FIG. 1 presents an exemplary view of the software stack implementing a foundation platform consistent with an embodiment of the invention;

FIG. 2 presents an exemplary view of the run-time architecture during operation consistent with an embodiment of the invention;

FIG. 3 presents an exemplary view of an inverted index in which metadata terms of a multimedia asset are posted and include customized payload fields consistent with an embodiment of the invention;

FIG. 4 presents an exemplary view of various types of Boolean temporal queries capable of being processed by the system consistent with an embodiment of the invention;

FIG. 5 presents an exemplary set of source segments that are capable of being indexed by the system consistent with an embodiment of the invention.

FIG. 6 presents an exemplary segments blob based on the source segments shown in FIG. 5, which include segment identifiers or pointers for inclusion in one of the payload fields of the inverted index consistent with an embodiment of the invention;

FIG. 7 presents an exemplary view of an inverted index in which metadata terms of a multimedia asset based on the source segments shown in FIG. 5 are posted consistent with an embodiment of the invention;

FIG. 8 presents an exemplary tree structure illustrating a simple Boolean search query run against metadata terms of a multimedia asset based on the source segments shown in FIG. 5 consistent with an embodiment of the invention;

FIG. 9 presents an exemplary tree structure illustrating a more complex Boolean search query having a phrase search component that is run against metadata terms of a multimedia asset based on the source segments shown in FIG. 5 consistent with an embodiment of the invention;

FIG. 10 presents an exemplary flow diagram for query processing consistent with an embodiment of the invention; and

FIG. 11 presents an exemplary flow diagram for content processing consistent with an embodiment of the invention.

### DETAILED DESCRIPTION OF PREFERRED EMBODIMENTS

Before the present methods and systems are disclosed and described in greater detail hereinafter, it is to be understood that the methods and systems are not limited to specific methods, specific components, or particular implementations. It is also to be understood that the terminology used herein is for the purpose of describing particular aspects and embodiments only and is not intended to be limiting.

As used in the specification and the appended claims, the singular forms “a,” “an” and “the” include plural referents unless the context clearly dictates otherwise. Similarly, “optional” or “optionally” means that the subsequently described event or circumstance may or may not occur, and the description includes instances in which the event or circumstance occurs and instances where it does not.

Throughout the description and claims of this specification, the word “comprise” and variations of the word, such as “comprising” and “comprises,” mean “including but not limited to,” and is not intended to exclude, for example, other components, integers, elements, features, or steps. “Exemplary” means “an example of” and is not necessarily intended to convey an indication of preferred or ideal embodiments. “Such as” is not used in a restrictive sense, but for explanatory purposes only.

Disclosed herein are components that can be used to perform the herein described methods and systems. These and other components are disclosed herein. It is understood that when combinations, subsets, interactions, groups, etc. of these components are disclosed that while specific reference to each various individual and collective combinations and permutation of these may not be explicitly disclosed, each is specifically contemplated and described herein, for all methods and systems. This applies to all aspects of this specification including, but not limited to, steps in disclosed methods. Thus, if there are a variety of additional steps that can be performed, it is understood that each of the additional steps can be performed with any specific embodiment or combination of embodiments of the disclosed methods and systems.

As will be appreciated by one skilled in the art, the methods and systems may take the form of an entirely new hardware embodiment, an entirely new software embodiment, or an embodiment combining new software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, non-volatile flash memory, CD-ROMs, optical storage devices, and/or magnetic storage devices, and the like. An exemplary computer system is described below.

Embodiments of the methods and systems are described below with reference to block diagrams and flowchart illustrations of methods, systems, apparatuses and computer program products. It will be understood that each block of the block diagrams and flow illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions, and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Most information retrieval (IR) systems use inverted indexes to provide for fast full-text searching. A document-level inverted index is similar to an index found in the back of a book in which the matching page numbers (documents) are listed for each term. This allows for basic set operations (e.g., intersection, union, not) to be used for AND, OR, and NOT queries, as described by the Standard Boolean Model. Many search engines use this index structure for basic asset-level queries that do not contain phrases. A word-level inverted index builds upon the document-level index by also storing the position of each word as it exists within each record. This allows for textual proximity and phrase searches to be performed.

However, a typical inverted index is limited to text and phrase type searching of content through textual context of the content that is the subject of the search. A traditional inverted index search has no provision for a search requiring temporal parameters such as, in a non-limiting example, start, stop, and duration timing for the appearance of desired content in video and multimedia content streams. Exploiting the temporal nature of video and multimedia content requires extending the search capability of a typical inverted index to include such temporal parameters. Metadata generation for newly created video and multimedia content contains such temporal parameters as a part of the metadata associated with such content. Thus, there is a need for an inverted index searching capability that takes advantage of temporal metadata that is generated in association with video and multimedia metadata.

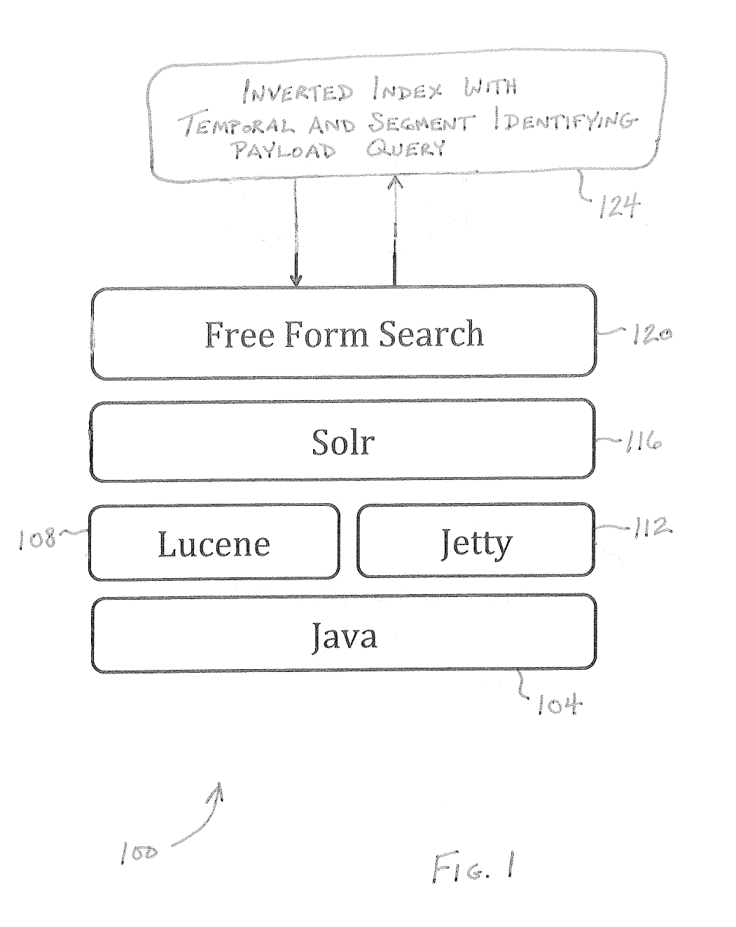

Turning now to FIG. 1, a diagram of an exemplary software stack 100 that provides the foundation platform for implementing the process for a word level search utilizing temporal payloads is illustrated. The software stack in this exemplary implementation is a series of layered software modules configured within a computer server to implement the foundational services and functions to perform word level searching with temporal payloads in response to queries for this service. At the most basic level, the software stack is founded upon the JAVA® language and foundation libraries. JAVA® is a general-purpose, concurrent, class-based, obj ect-oriented language that is specifically designed to have as few implementation dependencies as possible. JAVA® applications are typically compiled to bytecode (class file) that can run on any Java Virtual Machine (JVM) regardless of computer architecture. The word level search using temporal payloads application is created using the JAVA® language and foundation libraries to implement the application in this exemplary implementation.

Preferably, the software application used by the methods and systems described herein is written in Java 104, which then interacts through inter-process communication with the Lucene 108 full-text search library. Lucene 108 is a high-performance, full-featured text search engine library written in Java 104. In a preferred embodiment, the application is built on top of Apache Solr 116, which is a server wrapper around the Lucene 108 full-text search library. Solr 116 handles many of the common features and tasks that are typical to a Lucene-based search solution, such as configuration, index switching, index replication, caching, result formatting, spell-checking, faceting, as well as additional features. Solr also implements the Hypertext Transfer Protocol Application Programming Interface (HTTP API) for use in transferring information to and from users requesting search results from an Internet connection. Solr 116 uses the standard Servlet API, so that it can perform searching functions in answer to search queries with any JAVA® Servlet container; however, in the preferred embodiment, the application is built using a Jetty Servlet 112 container because it is fast, lightweight, and easy to embed. In a preferred embodiment, Solr 116 provides the connection between the Lucene 108 low-level full-text search library and the end user.

In a preferred embodiment the word level search with temporal payloads is implemented by first activating the Free Form Search 120 application that is in communication with Apache Solr 116. The Free Form Search 120 application uses inverted indexes to provide for fast full-text searching. This exemplary embodiment presents an expansion of the traditional record/document-level and word-level inverted index structures, which facilitates term and phrase searches, by adding temporal position information that allows for temporal queries, as discussed in greater detail hereinafter. The temporal positions are added to the Lucene 108 index using binary payloads.

In this exemplary embodiment an Inverted Index with Temporal and Segment Identifying Payload Query 124 initiates a Word Level search using the inverted index capability available in Lucene 108 that has been enhanced by the inclusion of temporal parameters and a segment identifier defined within a binary payload. A binary payload is metadata that is defined and associated with the current term within the query. Although binary payloads are defined as a metadata structure available for use in a Lucene 108 query, the structure is deliberately left open to allow for customization and inclusion of new query types. The metadata definition within the binary payload structure is therefore capable of being defined as a new type of binary data that has not previously been transmitted or used in Lucene 108 type queries. In the present system, temporal values and segment identifiers of metadata terms associated with a digital media asset may be used to enhance the search capabilities associated with a digital media asset, as described in greater detail below. The software modules necessary to capture, parse, interpret, and use the temporal payload metadata associated with a word level inverted index search 124 are defined and described herein.

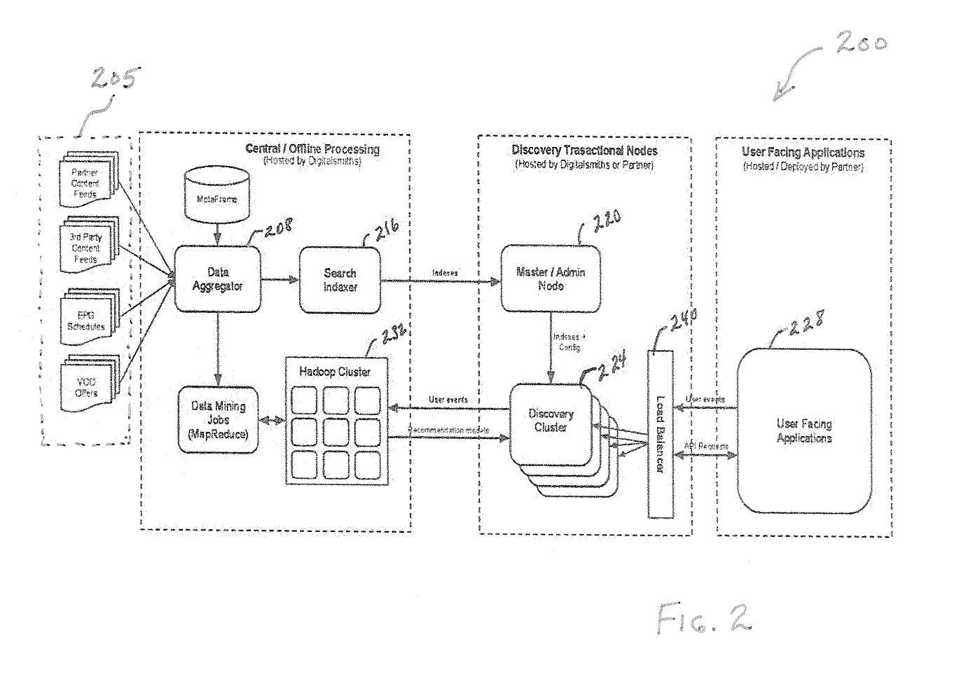

FIG. 2 illustrates one exemplary implementation of the system 200 for the accumulation and dissemination of multimedia digital content associated with time-based metadata against which queries may be processed. The content may be input from any number of input sources 205, including partner content feeds, metadata tagging operations, existing metadata transmitted from one or more content databases (such as, in a non-limiting example, a Video on Demand (VOD) database source), Electronic Programming Guide data, or from 3^{rd} party sources. Preferably, for any specific multimedia digital content, the present system provides support for multiple types of metadata associated with the digital content, including common attributes of the digital content that may be provided by the owner of the digital media, system-generated time-based metadata, and custom-defined tracks of time-based metadata. The system provides support for managing video metadata through the storage and manipulation of “segments.” Segments that designate a span of time in a multimedia asset, such as character appearances, scene boundaries, video breaks or ad cues, are collected together in groups known as “tracks.” A digital asset can have multiple metadata tracks that each span several different types of data, but can be stored and represented in a consistent manner. A segment represents a particular type of data that occurs at a point in time or span of time within a digital asset. Examples of a segment include the window of time in which a character appears in a scene or where a studio owns the digital rights to distribute a specific clip. Any information that can be represented as a duration or instant in time can be represented as a segment. A segment may be extended to capture additional information, such as detailed character information, extended rights management information, or what type of ads to cue. A track represents a collection of one or more segments and represents the timeline of data that spans the entire duration of a video asset.

In accumulating content and metadata from various input sources 205, data normalization may be required. In a non-limiting implementation, the raw data from a 3^{rd} party feed may be transformed to Java Script Object Notation (JSON) format and any required fields (title, releaseYear, etc.) are preferably populated, although it should be understood that the raw data transformation is not restricted to JSON format only and may be implemented in additional or alternative formats. In this exemplary implementation, additional fields may also be transformed to JSON format in order to be used effectively within Free Form Search (FFS) queries, including queries such as word level inverted index with temporal and segment identification payload queries.

The time-based metadata transmitted from the various input sources 205 is combined at a content data aggregator 208 maintained within the system that accumulates incoming content and metadata associated with the incoming content into a database maintained by the content aggregator 208. The content aggregator 208 transmits all received content and associated metadata to a Search Indexer 216 software module that creates indexes and inverted indexes for all received content, processing the incoming data to produce term/segment instances that have time-based metadata parameters associated with each term/segment instance. The Search Indexer 216 transmits all processed content to a Master/Administration server node 220 to persist the processed term/segment instances and indexes and maintains the metadata for content identification, location, replication, and data security for all content. After the metadata associated with the received content has been fully normalized and indexed, the indexed content is streamed to multiple transaction nodes in one or more Discovery Clusters 224 and the Master/Administrator node 220 may manage the direction of content location and manage the operation of queries against the master index database as required to provide results to user facing applications 228.

Multiple Discovery Cluster nodes 224 are preferably used to store content and provide for a network level distributed processing environment. The content is preferably distributed in a Distributed File System (DFS) manner where all metadata associated with the content to be managed by the DFS is concatenated with metadata describing the location and replication of stored content files and stored in a distributed manner such as, in a non-limiting example, within a database distributed across a plurality of network nodes (not shown). In this exemplary implementation, the content is preferably divided into manageable blocks over as many Discovery Cluster nodes 224 as may be required to process incoming user requests in an efficient manner. A load balancer 240 module preferably reviews the distribution of search requests and queries to the set of Discovery Cluster nodes 224 and directs incoming user search requests and queries in such a manner so as to balance the amount of content stored on the set of Discovery Cluster nodes 224 as evenly as possible among the transaction nodes in the set. As more Discovery Cluster nodes 224 are added to the set, the load balancer 240 directs the incoming content to any such new transaction nodes so as to maintain the balance of requests across all of the nodes. In this manner, the load balancer 240 attempts to optimize the processing throughput for all Discovery Cluster nodes 224 such that the amount of work on any one node is reasonably similar to the amount on any other individual Discovery Cluster node 224. The load balancer 240 thus provides for search operation optimization by attempting to assure that a search operation on any one node will not require significantly greater or less time than on any other node.

As stated previously, a document-level inverted index is similar to an index found in the back of a book in which the matching page numbers (documents) are listed for each term. This allows for basic set operations (e.g., intersection, union, not) to be used for AND, OR, and NOT queries as described by the Standard Boolean Model. A word-level inverted index builds upon the document-level index by also storing the position of each word or term, as it exists within each record. This allows for textual proximity and phrase searches to be performed. In addition to the word positions, in the present system, temporal positions are added to the inverted index to allow for temporal queries in addition to phrase queries to be run against the metadata terms associated with a multimedia or digital media asset. Advantageously, by also adding a specific segment identifier to each instance of a metadata term contained in the inverted index, it is possible for searches to be conducted against one or more discrete segment. In addition, such segment identifiers or pointers can be used quickly and readily to determine the context or rationale as to why each search result has been returned in response to a search query. The system makes use of Lucene's 108 binary payload functionality to store this additional binary data (temporal data and segment identifiers) for each term instance in the inverted index. The payloads are made up of three (3) variable-length integers, which account for twelve (12) extra bytes of metadata, that are stored for each term instance. The three integers include:
Time In/Start Time—which represents the start point of the segment in which the metadata term occurs (preferably rounded down to the nearest second);
Time Out/End Time—which represents the end point of the segment in which the metadata term occurs (preferably rounded up to the nearest second); and
Segment Identifier/Segment Offset—which identifies the unique segment of the multimedia asset with which the particular instance of the metadata term is associated. In some embodiments, the Segment Identifier is a unique identifier or a pointer to the relevant source segment associated with the multimedia asset. In a preferred embodiment, as part of the indexing process, all metadata segments associated with a digital media asset are serialized into a single, compressed file format, called hereinafter a source segment blob. The blob contains n number of bytes representing all of the discrete, serialized segments of the digital media asset source. If the first segment of the source segment blob is deemed to be at byte location 0, then the location of each segment can be identified by its byte offset location within the source segment blob. In that case, the Segment Identifier can also be referred to as a Segment Offset or Segment Byte Offset. Although some embodiments can use the unique segment ID or a pointer into the segment database containing the raw segment data, use of a serialized, compressed segment blob (e.g., a single file containing a mirror copy of all of the raw segments kept in the database) enables more efficient and quicker searching capability and faster search query responses since the data can be identified and/or retrieved more quickly from a single file than from a database.

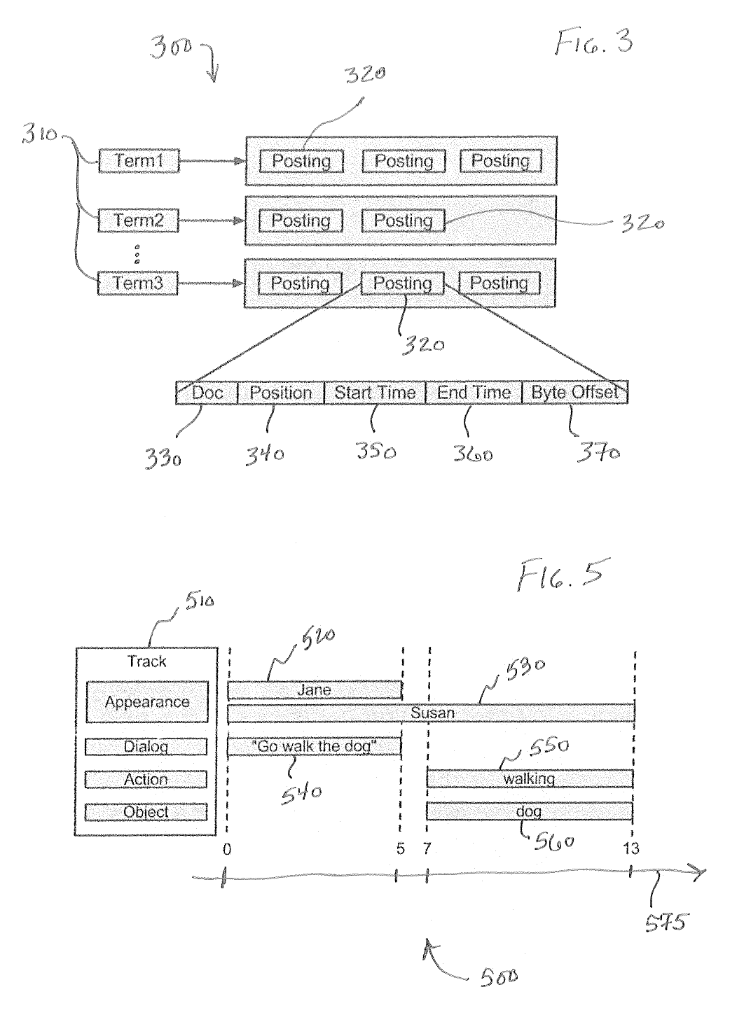

An inverted index 300 associating word order position data plus customized payload data to each metadata term being indexed is illustrated in FIG. 3. The process of creating the inverted index for each term 310 results in a separate posting 320 into the inverted index 300 for each occurrence of the metadata term within the multimedia asset. As shown, each posting 320 includes fields for the document number 330 of the relevant multimedia asset, the relative word position or location of the metadata term 340 (which is useful for proximity and phrase searches—particularly when searching dialog or specific quotes in the multimedia asset), and the three customized payload fields used herein: the Time In/Start Time 350, Time Out/End Time 360, and Segment Identifier/Segment Offset 370.

In a non-limiting example, a specific term utilizing temporal payloads may be modeled in the following form:

“term: {(D, P, [TI₁, TO₁, TS₁]), . . . , (Dₙ, Pₙ, [TIₙ, TOₙ, TSₙ]}”

where “term” is the metadata parameter being indexed or, thereafter, searched—wherein the metadata segments are associated with one or more multimedia, video, or other digital assets for which the present system has access. The metadata terms are stored in the master database in sorted temporal order to facilitate merge operations as additional terms are added to the master database and for greater optimization of query processing. In this non-limiting example, “D₁” is defined as the first content record that contains “term,” “P₁” is the word order position or location within the respective content record in which the “term” is located, “TI₁” is the first integer value of the defined temporal payload and represents the start point of the segment within the content record containing the “term,” “TO₁” is the second integer value of the defined temporal payload and represents the end point of the segment within the content record containing the “term,” and “TS₁” is the third integer value of the defined temporal payload and represents the segment identifier, database pointer, or byte offset (from initial byte=0 in a serialized blob of segments created for each digital asset) which indicates where that term instance can be found and quickly identified for that particular digital media asset. As may be seen in this non-limiting example, additional segments or content records may be associated with a single “term” indicating multiple locations for the same “term” within the multimedia, video, or other content asset to be searched, with the n^{th} location of “term” located at Dₙ, Pₙ, [TIₙ, TOₙ, TSₙ]. In this manner, multiple locations for each “term” may be retrieved with a single query and include the index values for the content record, location within that content record, starting and ending temporal values, and a segment for each unique occurrence of “term” in the content databases searched. Thus, in this exemplary embodiment, a search using an inverted index with temporal and segment identifier payload values 124 may return multiple locations for the term being searched in any and all content databases for which the application has search access.

The following specific example builds upon the previous example to indicate how payloads are stored in the index for two different digital assets and three different terms that are associated, in this example, with Tom Cruise. Each posting or instance of the term identified in the inverted index represents a separate and unique segment associated with its respective term. The document or asset number is indicated by the first digit. The relative position or location of that term, vis a vis other terms that occur in the same respective document, is indicated by the second digit. The three payload values (start time, stop time, and segment identifier) are represented within the square brackets:

tom: {(1, 2, [300, 303, 0]), (1, 7, [500, 510, 47]), (2, 3, [100, 120, 0]), . . . }

cruise: {(1, 3, [300, 303, 0]), (1, 9, [700, 704, 23]), (2, 4, [100, 120, 0]), . . . }

dancing: {(2, 20, [70, 105, 501]), . . . }

In this example, if a search were conducted for ‘tom AND cruise AND dancing,’ a document level search would merely return document 2 as the relevant asset containing all three terms. However, with the present system, not only is document 2 identified, but the user is presented with the specific time-span within document 2 in which the three terms exist together—based on the intersection of the temporal in/out points from the matching term instances. In the example above, the resulting time span would be between time locations [100-105] within document 2. By identifying the specific segment for all three terms, based on each segment identifier, it is possible to reference the underlying raw segment data or segment blob to determine with what type of data or track each term is associated. For example, “Tom Cruise” could represent the actor appearing the digital asset, could identify the producer of the digital asset, or could represent a name mentioned by someone else in dialog associated with the digital asset. Similarly, the term “dancing” could identify the genre of the digital asset, a term in the title of the asset, an action occurring by a character or actor within the asset, an action occurring in the background of a scene in the digital asset, a word spoken by a character in the asset, the name of a song playing in the background of a scene in the asset, or the like. Having this additional data and being able to retrieve it quickly for the user enables the user to determine if the search result is one desired by the user. If such search result is not the desired one (or if too many search results are returned), then having such segment information enables the user to reformulate the search query to fine tune or better target the search to obtain the desired result(s).

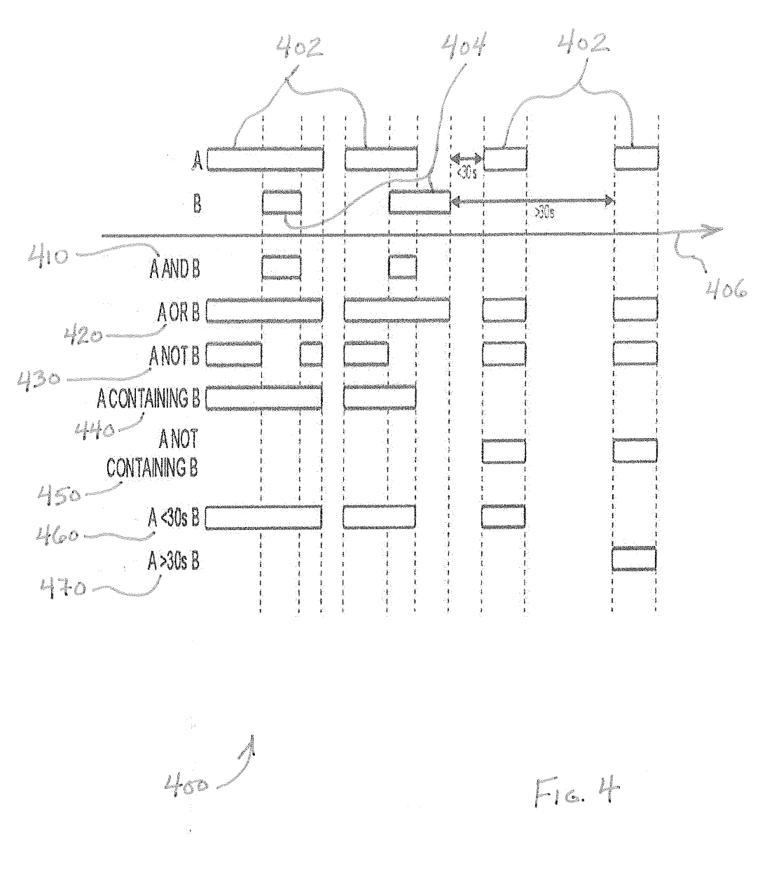

With reference to FIG. 4, an exemplary implementation of a Free Form Search (FFS) search using metadata incorporated within the customized payload associated with incoming content, which enables searches to be run against content using Boolean-type operators and operations, is illustrated. Queries submitted for action by the system are formatted as FFS queries first. By default, FFS searches across all metadata. However, because the metadata is organized on a field basis, it is advantageously possible to instruct FFS to match terms/phrases against only certain fields. For example, it is described above that a segment blob can be generated to contain all of the segments, in serialized format, for a digital asset. However, as will be appreciated by those skilled in the art, segment blobs can be generated for each separate track of metadata or even for a specific segment term; thus, allowing more targeted and quicker searching capabilities if the user knows that he is looking for one or more terms in a specific document, track, or segment type. Providing the capability to use a rich FFS query language allows for more expressive queries.

The FFS query language in the preferred embodiment allows phrases to be searched. By putting double quotes around a set of terms, FFS will search for the quoted terms in that exact order without any change (although it is customary for noise words, such as “a” and “the,” to be ignored). When no quotes are used, FFS will search for each of the words included the phrase in any order. For example, a search for [“Alexander Bell”] (with quotes) will miss any references that refer to Alexander Graham Bell or Bell Alexander. Using quotes also guarantees that only results with [“Alexander Bell”], in that exact order and without any intervening (non-noise) terms, are returned in response to such search query. All other results are filtered out.

The FFS query language also provides the capability to use fields within the query to control the subject of the query. Fields can be specified within the query itself. This is useful for cases in which the entire query should only be evaluated against a certain field, or when the user needs more precise control over or needs to narrow down the search results. Fields may be added to the query by prefixing the term(s) with the field name followed by a colon “:”. Additionally, wildcards may be placed within or directly after search terms for matching against multiple terms that share the same prefix and/or suffix. The “*” wildcard is used to match terms where the “*” is replaced by zero or more alpha-numeric characters. It is also possible to use the wildcard designator for the field, such as “*:term”. Further, it is also possible to use the wildcard for both the field and the term search (e.g., “*:*”), which will return all available titles. This can be helpful when the user desires to retrieve all documents in sorted order (by title, popularity, etc.), and can also be used to accomplish purely negative queries.

In a preferred embodiment, Boolean operators are also defined for use against incoming queries in the FFS query language. Boolean operators allow terms/phrases in the query to be combined through logic operators. By default, all terms in the query are preferably treated as though they are separated by an AND operator. This default requires that all terms in a particular search query be found together for a hit to be returned.

By way of example and not of limitation, FIG. 4 presents views 400 of the results of Boolean operations on content available for search for both contextual and time-based queries. For time-based searches, the AND, OR, and NOT operators are used to indicate how matches must relate to one another in time. In addition, the CONTAINING, NOT CONTAINING, NEAR (<), and NOT NEAR (>) operators can be used to express which matching time-spans should be returned. For purposes of illustration, two different terms, A and B, are shown as segments 402 and 404, respectively, with multiple instances, each having a discrete start and stop point along timeline 406, which represents the time range in which that parameter occurs within the digital media asset. Terms A and B may represent any relevant parameter or type of metadata associated with the underlying digital asset, such as actor name, character name, action, object, scene, or other content from the digital media asset. As stated previously, it is assumed that parameters and their time locations are available for all digital media assets stored within the content repositories or databases against which query operations are conducted. In this exemplary implementation, a first content set A presents the location of all content segments 402 containing the first parameter, and a second content set B presents the location of all content segments 404 containing the second parameter.

The AND operator is the default operator for all terms and phrases in an incoming query and is illustrated by the A AND B operation 410. The result for the A AND B operation 410 is the set of content segments in which both of the parameters of the content sets A and B are included; thus, excluding parameters that do not appear in both content set A and content set B. This operation results in a dataset that is an intersection of the content sets A and B. Thus, when a query expresses a search for the content segments in set A and B, the results presented to the user will contain thumbnails for all of the segments that appear in both sets of content, as well as the duration of each segment common to both content sets.

The OR operation is illustrated by the A OR B operation 420. The results for the OR operation includes the set of content segments that contains the parameters found in content set A, content set B, and the combination of both content set A and content set B. This operation results in a dataset that is a union of the content sets A and B. Thus, the OR operation presents the union of content set A and content set B, and the results presented to the user will contain thumbnails for all of the segments in content set A and content set B.

The NOT operation is illustrated by the A NOT B operation 430. The results set for the NOT operation is the set of content segments that contains the parameters defined for content set A, but any portion of the set of content segments that contains both the parameters defined for content set A and content set B is excluded from the results set. The results set presented to the user will contain thumbnails for all of the segments that contain the parameters of content set A but will specifically exclude the parameters defined for content set B.

In this exemplary embodiment, the CONTAINING, NOT CONTAINING, NEAR (<), and NOT NEAR (>) operators are defined specifically for time-based searches to express how results sets relate to one another across a time span. As illustrated, the CONTAINING operator is similar to the AND operator, except that the bounds of the returned time spans are based on the left-hand-side of the operator instead of the intersection of the left-hand-side and right-hand-side. The CONTAINING operator presents results of each content segment for content set A that contain any parameter(s) of content set B, and for any duration of the parameter(s) of content set B, even if the parameter(s) is found in only one frame of any content segment in content set A. As a non-limiting example, the results set for this operation are shown by the A CONTAINING B operation 440. The results consist of the content segments that contain only those content set A segments containing the parameters defined for content set A that also contain the parameters defined for content set B.

The NOT CONTAINING operator is similar to the CONTAINING operator, except that it returns time spans that do not overlap one another. As a non-limiting example, the results set for this operation are shown by the A NOT CONTAINING B operation 450. The results consist of the content segments that contain only those content set A segments that do not contain any content segments containing the parameters defined for content set B.

The NEAR (“<”) operator is used to find occurrences of one set of matches that are within a defined proximity of another set of matches. The proximity is preferably specified after the “<” operator in the form <max distance> <units>, where units can be ‘s’ (for seconds), or ‘in’ (for minutes), by way of example. In this non-limiting example, the results set for this operation is shown by the A <30 s B operation 460. The results consist of the content segments from content set A that are within the specified time span (in this example, 30 seconds) from any content segments found for content set B. However, as will be understood by those skilled in the art, the time span defined as the <max distance> parameter may be any time span expressed as any defined unit of time, and is not specifically limited to the presented example.

The NOT NEAR (“>”) operator is used to find occurrences of one set of matches that are outside of a defined proximity of another set of matches. As in the definition for the NEAR operator, the proximity is preferably specified after the “>” operator in the form <max distance> <units>, where units can be ‘s’ (for seconds), or ‘in’ (for minutes), by way of example. In this non-limiting example, the results set for this operation is shown by the A >30 s B operation 470. The results consist of the content segments from content set A that are outside of the specified time span (in this example, 30 seconds) from any content segments found for content set B. In a non-limiting example, the A >30 s B operation 470 returns all results of content set A that are not within 30 seconds prior to or 30 seconds after the instances of content set B. Thus, the <max distance> parameter is operative in both temporal directions with regard to content set A. However, as will be understood by those skilled in the art, the time span defined as the <max distance> parameter may be any time span expressed as any defined unit of time, and is not specifically limited to the presented example.

When multiple operators are used within a query, the order in which the operators are evaluated is non-deterministic. As will be known to those of skill in the art, the order of evaluation can be explicitly controlled by using parentheses within the query to determine the order of operation for all search terms specified in the query. Additionally, parentheses can also be used to apply multiple terms/clauses to a single field so as to define an order of precedence for search of each term in a single search field. Range clauses allow terms to be found that have field value(s) within a given set of lower and upper bounds. The bounds can be specified as either inclusive (by using square brackets [ ]), or exclusive (by using curly braces { }).

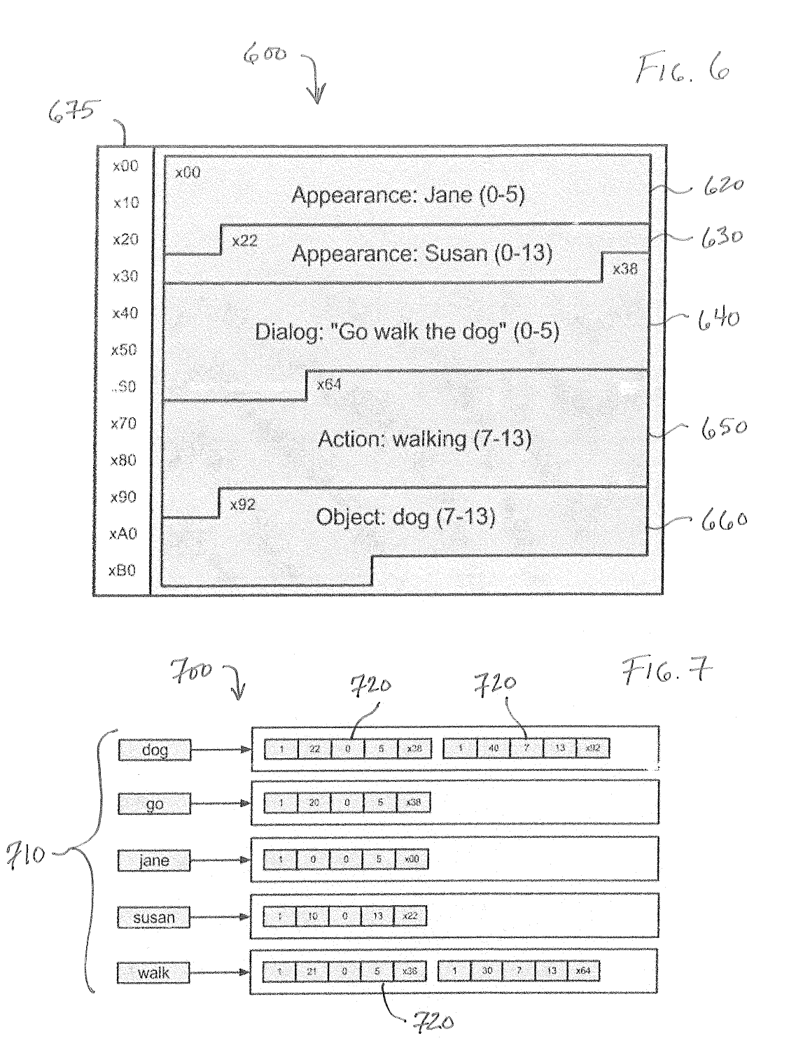

FIG. 5 illustrates an exemplary set 500 of source segments that are capable of being indexed by the system. In this example, there are four different types of tracks 510, including appearance, dialog, action, and object, associated with this particular portion of a single digital asset. Only thirteen seconds of this digital asset are reflected along timeline 575, in this example. There are two different segments within the appearance track, Jane 520 and Susan 530.

There is one dialog segment 540, for the phrase “Go walk the dog.” There is one action segment 550, for the activity of walking being done by someone in this particular scene. And there is one object segment 560, representing the physical appearance of a dog, which, in this case is treated as an object and not an actor or character within the appearance track. As will be appreciated by one skilled in the art, the above set of source segments, tracks, and timeline represent a portion of an exemplary scene in a movie or TV show. For this particular example, one can imagine a scene in which Jane says to Susan “Go walk the dog” in the first 5 seconds of the scene, and then Susan actually goes to walk the dog between seconds 7 and 13 of the scene. This simple scene and the underlying set 500 of source segments shown in FIG. 5 can then be used to illustrate, in the following FIGS. 6-9, how an inverted index, having temporal and segment identifier payloads, can be created and searched to find specific portions of a scene in response to two simple search queries.

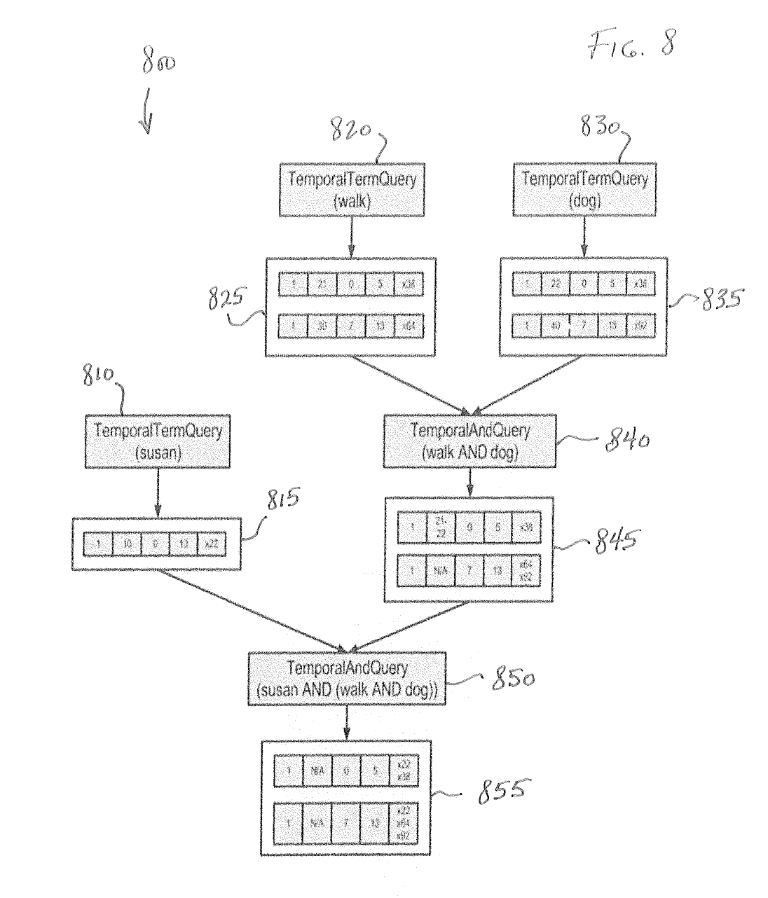

Turning now to FIG. 6, an exemplary segments blob 600 corresponding with the scene from FIG. 5 is shown. In a preferred embodiment, in addition to being stored as postings within the inverted index (see FIG. 7), the original source segments 520-560 from FIG. 5 are also stored in raw form within the segments blob 600 to allow for efficient retrieval of the relevant segments for display within the result set in response to a search query. The blob 600 itself is stored within a single Lucene stored field, preferably, for each document. Preferably, the blob contains all of the segments and tracks associated with the particular document. However, as stated previously, in some embodiments, it may be useful to have separate blobs created for one or more tracks or even one or more specific segments to speed up search and retrieval processes. In addition, although the preferred embodiment illustrates uses of segment blobs for the sake of efficiency, one with skill in the art will appreciate that use of a segment identifier or a pointer to a database, rather than to a single Lucene field or single file, can be used to similar effect. The binary format of each segment within the blob 600 is controlled by a Segment.writeExternal( ) command and may vary from release-to-release or with different programming languages or protocols. More importantly, in the preferred embodiment that makes use of the segments blob 600, the byte offset of each segment within the blob, shown by the byte location field 675, is stored on each inverted index posting, which is the critical pointer to allow for easy and rapid retrieval of the segments relevant to each search query hit. FIG. 6 illustrates one manner in which the segments blob 600 could be constructed for the source segments from FIG. 5. Specifically, the Appearance: Jane segment 620, which has a time range from 0 to 5, is located at/starts at byte offset x00 (through x21) within the byte location field 675 of the segments blob 600. The Appearance: Susan segment 630, which has a time range from 0 to 13, starts at byte offset x22 (and continues through x37) within the byte location field 675. The Dialog: “Go walk the Dog” segment 640, which has a time range from 0 to 5, is located at byte offset x38 (through x63) within the byte location field 675. The Action: walking segment 650, which has a time range from 7 to 13, starts at byte offset x64 (and continues through x91) within the byte location field 675. The Object: dog segment 660, which has a time range from 7 to 13, is located at byte offset x92 within the byte location field 675 of the segments blob 600. It should be noted that the contents of each source segment are summarized within the respective field locations within the segments blob 600; however, in practice, each segment's data will preferably be stored in a compressed binary format.

FIG. 7 illustrates the specific postings that are created as part of generating an inverted index 700 of the source segments shown in FIG. 5. Specifically, the postings shown in FIG. 7 are the result of indexing the segments from FIG. 5 after stop word removal, stemming, and lowercasing have been applied to normalize the terms 710. Note that the track information from the source segments has been ignored in this example. Each posting 720 of the inverted index 700 represents a separate and discrete segment associated with each term 710. As was illustrated generically in FIG. 3, each posting 720 includes five fields: the first field for the document number of the relevant multimedia asset, the second field identifying the relative word position or location of the metadata term within that relevant multimedia asset (which is useful for proximity and phrase searches—particularly when searching dialog or specific quotes in the multimedia asset), and the three customized payload fields: the Time In/Start Time, the Time Out/End Time, and the Segment Identifier/Segment Offset. Preferably, FIG. 7 illustrates how the segment data is indexed within the “temporalText” field, which allows for queries across all tracks. However, in a preferred embodiment, FFS also indexes the segments organized by track and attribute-name.

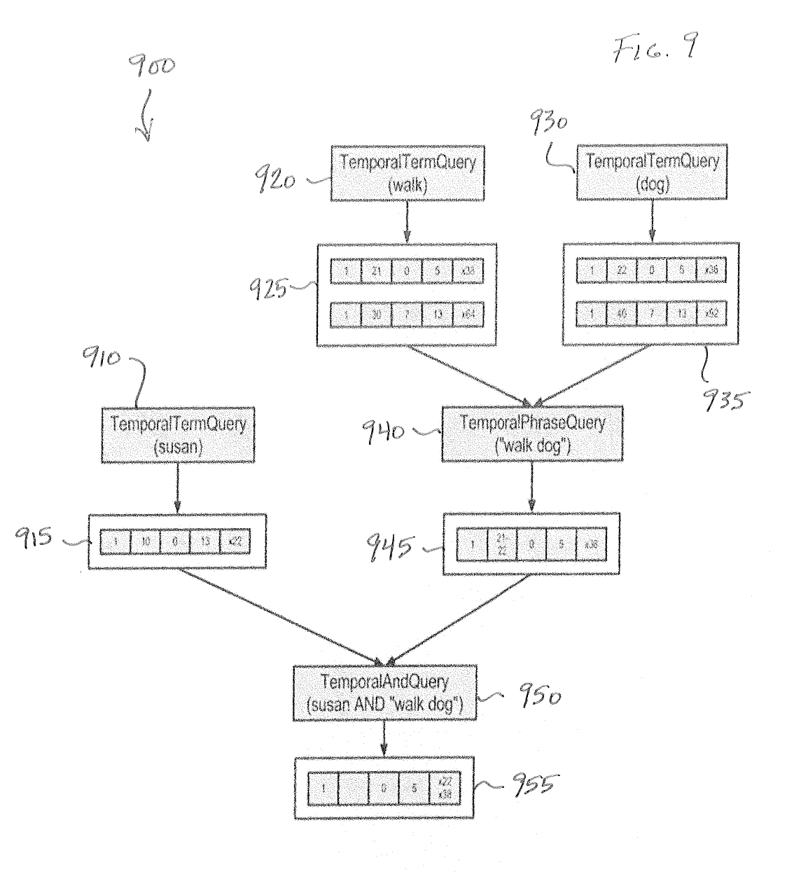

FIG. 8 illustrates an exemplary query tree 800 that results from a simple AND query of the terms ‘susan’ and ‘walk/walking’ and ‘dog.’ The query tree 800 illustrates the queries 810, 820, 830 generated for the three terms being searched. The corresponding postings 815, 825, 835 are retrieved from the inverted index. The ANDing of ‘walk’ and ‘dog’ results in intermediate query result 840 having its corresponding posting 845. The ANDing of query 815 for ‘susan’ with the intermediate query result 840 for ‘walk’ and ‘dog’ results in final query result 850 and its corresponding posting 855. The final query result posting 855 illustrates that these three terms, susan, walk/walking, and dog, exist in two locations: (1) within document 1, between time 0 and 5, and is associated with the segments located within the segments blob 600 from FIG. 6 at byte offsets x22 and x38, and (2) within document 1, between time 7 and 13, and is associated with the segments located within the segments blob 600 from FIG. 6 at byte offsets x22, x64, and x92. The first location identifies the intersection of Susan appearing within the scene at the same time that the phrase “Go walk the dog” occurs. The second location identifies the intersection of Susan appearing within the scene at the same time there is an action of walk/walking and at the same time that an object of a dog appears within the scene.

The query tree 800 produces a nested set of TemporalAndQuery objects since each Boolean operation can only accept two TemporalQuery terms as inputs. It should be noted that the results of each TemporalTermQuery is simply just the list of postings for the given term from the inverted index. The execution of the queries takes place in parallel, meaning that the final TemporalAndQuery only reads enough inputs from its incoming queries to determine whether to return a positive search result or not, and so on up the chain of queries. This helps to preserve memory during query execution and also allows for efficient “skipping” of invalid candidate postings.

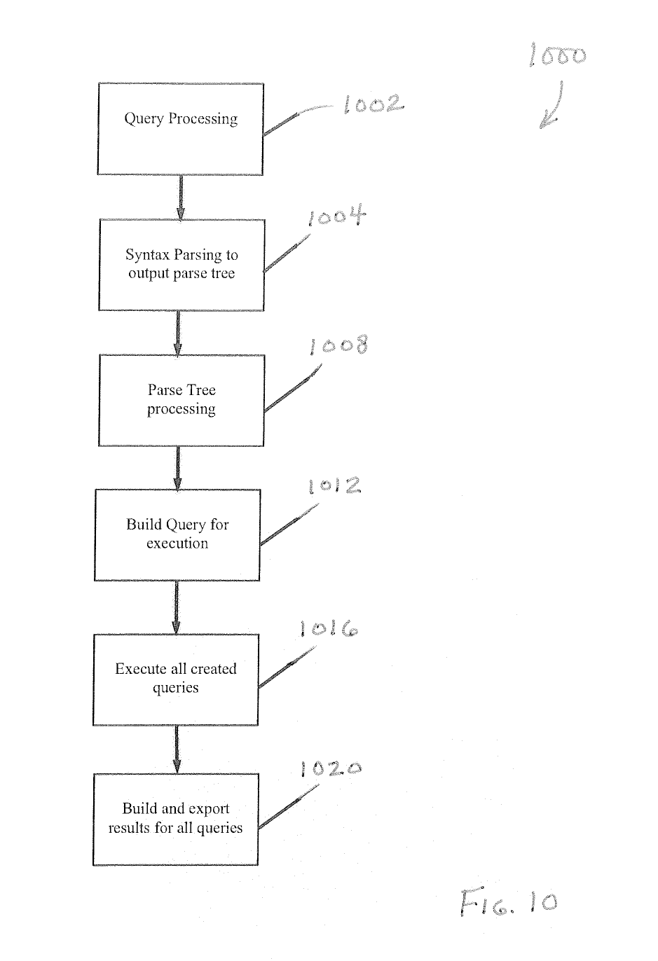

FIG. 9 illustrates another exemplary query tree 900 that is similar to the AND query tree from FIG. 8; however, the end-user query mixes a single term along with a phrase. In this example, the term ‘susan’ ANDed with the phrase “‘walk the dog’”.

This example makes use of both the word positions and temporal start/end times from the postings in the index. The TemporalPhraseQuery produces results by checking for adjacency of the word positions (second field) in each source posting, while the TemporalAndQuery produces the temporal intersections of its sources by making use of the temporal start/end times. This produces only a single search hit or location (i.e., within document 1, between time 0 and 5, and is associated with the segments located within the segments blob 600 from FIG. 6 at byte offsets x22 and x38) in contrast to the two search results/locations produced by the AND query from FIG. 8.

Specifically, query tree 900 illustrates the queries 910, 920, 930 generated for the three terms being searched. The corresponding postings 915, 925, 935 are retrieved from the inverted index. The ANDing of the phrase “walk dog” results in intermediate query result 940 having its corresponding posting 945; however, the phrase search only returns the dialog hit for the phrase “Go walk the dog” and does not return the posting for the scene in which there is an action of walk/walking at the same time that an object of a dog appears within the scene. The ANDing of query 915 for ‘susan’ with the intermediate query result 940 for the phrase “walk dog” results in final query result 950 and its corresponding posting 955. As stated above, the final query result posting 955 illustrates that the term, susan, only appears in one location when the phrase “walk dog” occurs within dialog.

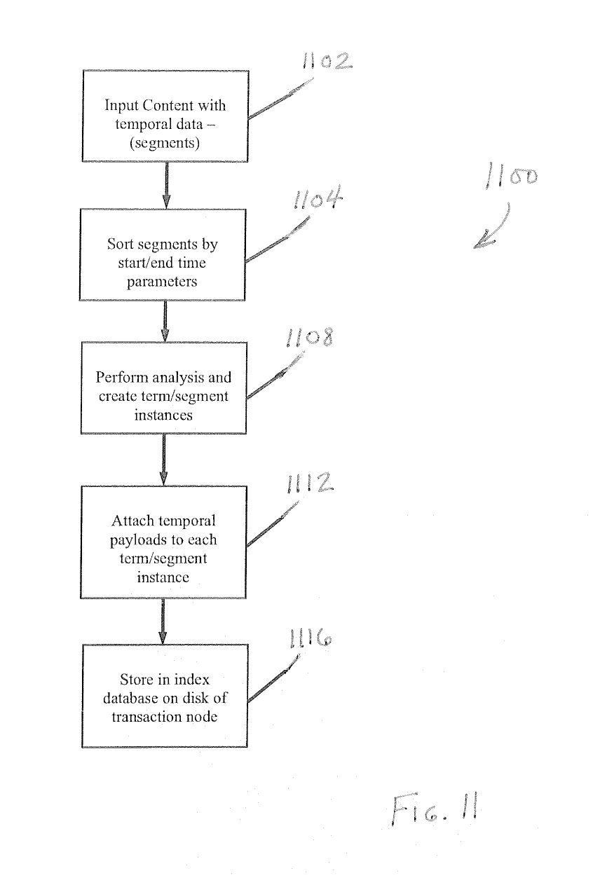

With regard to FIG. 10, one preferred query process 1000 of the system is illustrated. The overall goal of query parsing is to transform a user-entered query string into a nested set of Query objects. The system encompasses a unique set of temporal Query classes and supports an internally defined set of temporal operators through the extension of Lucene's built-in query parser. Internally defined query classes have been included in the queryparser contrib library, extending the standard query processing capability to include the ability to parse and process queries containing temporal and segment identifier payload information. Query process 1000 begins with the receipt of queries from a user facing application at step 1002.

In the exemplary implementation, the query is first received at a syntax-parsing module to create and output a parse tree 1004 for the query. The syntax-parsing step 1004 creates a parse tree of QueryNodes from the raw query. The syntax-parsing module creates a parse tree where the QueryNodes consist of terms submitted with the query and the operations required to link the terms. The linking operations consist of operations such as AND, OR, and NOT operators and CONTAINING, NOT CONTAINING, NEAR, and NOT NEAR temporal operators. The parsing is handled by a parser class (FFSSyntaxParser.java), which is generated from a javacc grammar file (FFSSyntaxParser.jj). The grammar is based upon syntax incorporated in Lucene and modified to support the CONTAINING, NEAR, and NOT NEAR operators generated for use with temporal queries. The created parse tree is output for further processing.

At step 1008 the parse tree of QueryNodes is received at the parse tree-processing module for further processing to modify the input parse tree further. After the raw query string has been parsed into a tree of nodes, each node within the tree is visited by a set of processors that may operate on one, some, or all of the nodes optionally to modify, expand, or delete each node. Nodes, including all search terms and the operations associated with each term, that are output from this step 1008 are in elemental form and are in condition to be used in building the search to be performed against one or more content databases.

At step 1012, the Query Building stage takes the processed tree, and creates a nested set of Query objects. In most cases, this is a simple one-to-one mapping between QueryNode classes, and a corresponding Query class. Depending on which type of query the user is executing (tag, TagAndTime, or time), either basic Lucene Query objects are constructed, or internally defined TemporalQuery equivalents are constructed. In this preferred embodiment, TemporalQuery objects include:
TemporalTermQuery—this is the lowest-level (atom) query. For single term queries, this class will stand-alone, but is more commonly nested within other Query objects when users enter more than one search term. This class iterates through each matching doc/position, reads the temporal payload at the given position and returns the start/stop times for that position. This class and the code to read the payloads is highly optimized as TemporalTermQuery.
TemporalTermSpans.next( ), is the operation to move to the next position and could potentially be called millions of times during a single request based on the complexity of the query and number of documents/segments in the index.
TemporalOrQuery—produces the union or superset of its inputs. The resulting spans are not actually combined together, but are returning in increasing order of startTime/endTime. If needed, the FlattedSpans or CollatedSpans class can be used to combine the results into a single set of non-overlapping spans.
TemporalNearQuery—The TemporalNearQuery may be used for both the AND and NEAR(<) operators. When used to process the AND operator, the maxDistance value is set to 0, and the intersection of term A and term B is returned instead of just the data associated with term A. Operations utilizing the near algorithm are required to determine whether to advance term A or term B after a hit has been found, which can be a difficult objective to achieve. To determine whether to advance term A or term B and perform the action, the class uses a SpanEnumerator, which allows the next element of term A and term B to be inspected before advancing either term.
TemporalContainsQuery—is similar to the TemporalNearQuery, but has been implemented as a separate function to take advantage of the fact that all hits are based around the time spans associated with term A. This permits the elimination of the operation that finds the next term A or term B to increment (based on which is “smaller”) because the algorithm preferably always increments term A.
TemporalNotQuery—subtracts the results of the ‘exclude’ query from the results of the ‘include’ query. Unlike a typical Boolean NOT operation, which is implemented as a relative complement set operation, this class actually subtracts the ‘exclude’ spans from the ‘include’ spans, which can produce partial spans in the result and may actually cause more spans to be produced than were in the original included set (e.g., if an exclude span falls in the middle of an include span, 2 resulting spans are returned). This can cause confusion when trying to validate hit counts.
TemporalNotContainsQuery—this returns spans from the ‘container’ query that do not overlap/intersect at all with spans from the ‘contained’ query. In contrast to the TemporalNoQuery, this query behaves like a more typical NOT operation where the result is the relative complement of the set of ‘contained’ spans in the set of ‘container’ spans.
   At step 1016, after all queries have been created, the system advances to the execution of all created queries. Each created query is executed against one or more content database. Content that meets the criteria expressed in each of the created queries is returned to build a result in JSON format. The results are concatenated and exported at step 1020 to the discovery cluster to which the original user query was submitted for processing. The discovery cluster then exports the results, in a format consistent with the user facing application, to the user requesting the search.

FIG. 11 illustrates an exemplary process flow 1100 for the inclusion of content indexed with temporal metadata associated with the incoming content. The content is stored in accordance with one or more inverted indexes created using temporal metadata values associated with the content.

At step 1102 in the exemplary implementation, content is input to the system through connections with one or more content providers. The content providers may be partner content feeds, Electronic Programming Guide (EPG) schedules, Video On Demand (VOD) offers, 3^{rd} party feeds, or any other content provided through contracts with additional content providers. The content received by the system contains metadata including id, guide, title, description, and temporal field values of start time and end time, as well as any other metadata that may be associated with the incoming content. The incoming content is processed to create content segments that may be of any specified length, such as scene length, shot length, or frame length in duration, where the specified segment length is pre-determined by one or more system configuration values. Each segment created has all of the general metadata associated with the segment as well as start time, end time, and time offset temporal data for each segment.

At step 1104, content segments are indexed to optimize later search operations. In this exemplary implementation, the index operation sorts the incoming segments by the start time and end time parameters and stores them within the index database in sorted order. This index step enables the temporal queries efficiently to apply Boolean operations across the segments in a single-pass at query-time.

At step 1108 the system performs text analysis of the metadata associated with the content to process the incoming content with regard to tokenizing, stemming, identifying synonyms, and other textual analysis as required. The result of the textual analysis consists of term/segment instances for every segment in the incoming content. At step 1112 the system attaches temporal payload metadata information in the form of start time and end time, and segment identifier or segment byte offset data for each segment blob to each term/segment instance created as the result of the textual analysis. At step 1116 all of the created content term/segments with associated temporal and segment identifier payload metadata is recorded in persistent storage. The content is stored in the index database maintained on a master/administrator node in the system.

It is to be understood that the system and methods which have been described above are merely illustrative applications of the principles of the invention. Numerous modifications may be made by those skilled in the art without departing from the true spirit and scope of the invention.

In view of the foregoing detailed description of preferred embodiments of the present invention, it readily will be understood by those persons skilled in the art that the present invention is susceptible to broad utility and application. While various aspects have been described in the context of screen shots, additional aspects, features, and methodologies of the present invention will be readily discernable therefrom. Many embodiments and adaptations of the present invention other than those herein described, as well as many variations, modifications, and equivalent arrangements and methodologies, will be apparent from or reasonably suggested by the present invention and the foregoing description thereof, without departing from the substance or scope of the present invention. Furthermore, any sequence(s) and/or temporal order of steps of various processes described and claimed herein are those considered to be the best mode contemplated for carrying out the present invention. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in various different sequences and orders, while still falling within the scope of the present inventions. In addition, some steps may be carried out simultaneously. Accordingly, while the present invention has been described herein in detail in relation to preferred embodiments, it is to be understood that this disclosure is only illustrative and exemplary of the present invention and is made merely for purposes of providing a full and enabling disclosure of the invention. The foregoing disclosure is not intended nor is to be construed to limit the present invention or otherwise to exclude any such other embodiments, adaptations, variations, modifications and equivalent arrangements, the present invention being limited only by the claims appended hereto and the equivalents thereof.

We Claim:

1-39. (canceled)

40. A system for indexing multimedia digital content, comprising:
receiving at a data aggregator time-based metadata associated with the multimedia digital content, the time-based metadata being organized into a plurality of raw content segments;
storing the plurality of raw content segments in a database in electronic communication with the data aggregator, each of the raw content segments being retrievable from the database based on a segment identifier assigned to each of the respective raw content segments;
using a computer processor to normalize the plurality of raw content segments; and
creating a searchable inverted index for the multimedia digital content that defines a segment instance for each occurrence of the textual description of the plurality of normalized content segments associated with the time-based metadata, where each segment instance is associated with at least one of the plurality of raw content segments stored in the database.

41. The system of claim 40, where, in response to a time-based search query containing at least one term, the system identifies from the searchable inverted index each raw segment instance, comprising a textual description and a time-based portion of the multimedia digital content, associated with the at least one term, and retrieves from the database the raw content segments and the time-based portion of the multimedia digital content associated with each raw segment instance.

42. The system of claim 40, where each segment instance includes data fields containing: (i) a word order position assigned to the respective term from the textual description, (ii) the start time of the normalized content segment containing the respective term, (iii) the stop time of the normalized content segment containing the respective term, and (iv) the segment identifier of the associated at least one raw content segment stored in the database.

43. The system of claim 42, where the word order position assigned to the respective term enables searching of multi-term phrases.

44. The system of claim 40, where the segment identifier is a pointer to the database.

45. The system of claim 40, where the database comprises a segments blob of data, where the segments blob comprises a plurality of raw content segments stored in a sequential time order.

46. The system of claim 45, where the segment identifier is unique and comprises a byte offset value associated with the bytes of data within the segments blob.

47. The system of claim 40, where normalizing the plurality of raw content segments includes making data fields of the raw content segments consistent regardless of their source, and
the time-based portion of the multimedia digital content comprises a start and stop time of each respective raw content segment and the segment identifier, start time, and stop time of each respective raw content segment are stored in binary payload data fields.

48. A method for identification and indexing of time-based portions of a multimedia digital content asset, comprising:
receiving time-based metadata associated with a multimedia digital content asset, the time-based metadata being organized into a plurality of raw content segments;
storing the plurality of raw content segments in a database, each of the raw content segments being retrievable from the database based on a segment identifier assigned to each of the respective raw content segments;
normalizing in a computer processor the plurality of raw content segments, where the textual description of each raw content segment includes one or more terms;
creating a searchable inverted index for the multimedia digital content that defines a segment instance for each occurrence of the one or more terms from the textual description of the plurality of normalized content segments associated with the time-based metadata, where each segment instance is associated with at least one of the plurality of raw content segment stored in the database.

49. The method of claim 48 further identifying, in response to a time-based query containing at least one term, each raw content segment instance, comprising a textual description and a time-based portion of the multimedia digital content asset, associated with an input search query; and
retrieving the respective time-based portion of the multimedia digital content defined by each of the retrieved raw content segments where one or more of the retrieved respective time-based portions of the multimedia digital content represent the identified time-based portion of the multimedia digital content.

50. The method of claim 48, where each segment instance includes data fields containing: (i) a word order position assigned t the respective term from the textual description, (ii) the start time of the normalized content segment containing the respective term, (iii) the stop time of the normalized content segment containing the respective term, and (iv) the segment identifier of the associated at least one raw content segment stored in the database.

51. The method of claim 50, where the word order position assigned to the respective term enables searching of multi-term phrases.

52. The method of claim 48, where the segment identifier is a pointer to the database.

53. The method of claim 48, where the database comprises a segments blob of data, and where the segments blob further comprises a plurality of raw content segments stored in a sequential time order.

54. The method of claim 53, where the segment identifier is unique and comprises a byte offset value associated with the bytes of data within the segments blob.

55. The method of claim 48, where normalizing the plurality of raw content segments includes making data fields of the raw content segments consistent regardless of their source, and
the time-based portion of the multimedia digital content comprises a start and stop time of each respective raw content segment and the segment identifier, start time, and stop time of each respective raw content segment are stored in binary payload data fields.

56. A computer program product embodied in a computer readable medium that when executed within a computer processor provides for identification of time-based portions of a multimedia digital content asset, comprising:
receiving time-based metadata associated with a multimedia digital content asset, the time-based metadata being organized into a plurality of raw content segments;
storing the plurality of raw content segments in a database, each of the raw content segments being retrievable from the database based on a segment identifier assigned to each of the respective raw content segments;
normalizing through the use of a computer processor the plurality of raw content segments, where the textual description of each raw content segment includes one or more terms;
creating a searchable inverted index for the multimedia digital content that defines a segment instance for each occurrence of the one or more terms from the textual description of the plurality of normalized content segments associated with the time-based metadata, where each segment instance is associated with at least one of the plurality of raw content segment stored in the database.

57. The method of claim 56 further identifying, in response to a time-based query containing at least one term, each raw content segment instance, comprising a textual description and a time-based portion of the multimedia digital content asset, associated with an input search query; and
retrieving the respective time-based portion of the multimedia digital content defined by each of the retrieved raw content segments where one or more of the retrieved respective time-based portions of the multimedia digital content represent the identified time-based portion of the multimedia digital content.

58. The computer program product of claim 56, where each segment instance includes data fields containing: (i) a word order position assigned t the respective term from the textual description, (ii) the start time of the normalized content segment containing the respective term, (iii) the stop time of the normalized content segment containing the respective term, and (iv) the segment identifier of the associated at least one raw content segment stored in the database.

59. The computer program product of claim 58, where the word order position assigned to the respective term enables searching of multi-term phrases.

60. The computer program product of claim 56, where the segment identifier is a pointer to the database.

61. The computer program product of claim 56, where the database comprises a segments blob of data, and where the segments blob further comprises a plurality of raw content segments stored in a sequential time order.

62. The computer program product of claim 60, where the segment identifier is unique and comprises a byte offset value associated with the bytes of data within the segments blob.

63. The computer program product of claim 56, where normalizing the plurality of raw content segments includes making data fields of the raw content segments consistent regardless of their source, and
the time-based portion of the multimedia digital content comprises a start and stop time of each respective raw content segment and the segment identifier, start time, and stop time of each respective raw content segment are stored in binary payload data fields.
